(19) United States
(12) Patent Application Publication
(10) Pub. No.: US 2015/0378879 A1
(43) Pub. Date: Dec. 31, 2015

(54) METHODS, SOFTWARE, AND SYSTEMS FOR SOFTWARE TESTING

(71) Applicant: Li Ding, Shanghai (CN)

(72) Inventor: Li Ding, Shanghai (CN)

(21) Appl. No.: 14/319,786

(22) Filed: Jun. 30, 2014

(51) Int. Cl. G06F 11/36

(52) U.S. Cl. CPC G06F 11/3688

(57) ABSTRACT

An embodiment of a method of testing software can include, as performed by at least one computing device, evaluating a first criterion for a plurality of software components, selecting a subset of the plurality of software components based on the evaluated first criterion, evaluating a second criterion for a plurality of test cases each defining a respective test to evaluate functionality of at least one of the software components, selecting a subset of the plurality of test cases based on the evaluated second criterion, and testing the selected subset of the plurality of software components utilizing the selected subset of the plurality of test cases.

### BACKGROUND INFORMATION

Testing is performed on software systems to ensure that they function at intended quality levels prior to distribution. Such testing can be performed in a variety of ways, but often involves executing test cases, which define specific tests to be conducted, on individual components of a software system, which typically includes multiple such components.

In one scenario, to ensure a high quality of the software system, each test case is executed on each component of the system. When the software system being tested is of a relatively small scale, involving only a relatively small number of components and test cases, such comprehensive testing can be conducted at relatively small cost.

However, increasingly, software systems are being developed on a relatively large scale, and involve a relatively large number of software components and test cases. For such large scale software systems, comprehensive testing becomes problematic. For example, development of a large scale software system may produce hundreds of software components each day, and executing a correspondingly large suite of test cases on even one such component may take dozens of computers upwards of a day to perform, thus executing this test suite on each of the components produced in only a single day may take the same dozens of computer hundreds of days to perform. Such an approach is prohibitively costly in terms of time and resources.

Therefore, a need exists for an improved way of testing large scale software systems that ensures a sufficiently high quality of the software system but does not prohibitively consume time and resources.

### BRIEF DESCRIPTION OF THE DRAWINGS

So that features of the present invention can be understood, a number of drawings are described below. However, the appended drawings illustrate only particular embodiments of the invention and are therefore not to be considered limiting of its scope, for the invention may encompass other equally effective embodiments.

FIG. 1 is a schematic diagram depicting an embodiment of a software development and testing system.

FIG. 2 is a schematic diagram depicting an embodiment of a client device of the software development and testing system.

FIG. 3 is a schematic diagram depicting an embodiment of a server of the software development and testing system.

FIG. 4 is a flowchart depicting an embodiment of a method of testing software.

FIG. 5A is a timeline depicting an exemplary performance of an embodiment of the method of testing software.

FIG. 5B is a timeline depicting another exemplary performance of an embodiment of the method of testing software.

### DETAILED DESCRIPTION OF EXAMPLE EMBODIMENTS

An embodiment of a method of testing software can include, as performed by at least one computing device, evaluating a first criterion for a plurality of software components, selecting a subset of the plurality of software components based on the evaluated first criterion, evaluating a second criterion for a plurality of test cases defining respective tests to evaluate functionality of the software components, selecting a subset of the plurality of test cases based on the evaluated second criterion, and testing the selected subset of the plurality of software components utilizing the selected subset of the plurality of test cases.

In an embodiment, the method enables an improved software testing by selecting only a subset of the received plurality of software components to undergo testing that may be most in need of testing, and selecting only a subset of the plurality of the test cases to be executed that may be most likely to reveal errors in the selected software components, reducing the time and resources required to conduct the software testing while still providing a high quality level for the software through the testing.

In embodiments of the method, the evaluating of the first criterion can include calculating a respective index for each of the plurality of software components and the evaluating of the second criterion can include calculating a respective index for each of the plurality of test cases. The selecting of the subset of the plurality of software components and the plurality of test cases can include selecting a predetermined percentage of the software components and test cases based on the calculated indexes for the software components and test cases, respectively.

The respective index for a corresponding software component can be a function of one or more of a number of times submission of the corresponding software module has been received in a predetermined time period or the times at which submission of the corresponding software component has been received in the predetermined time period. The respective index for a corresponding test case can be a function of one or more of a number of times the corresponding test case has returned a failure result for any software component in a predetermined time period or the times at which the corresponding test case has returned the failure result in the predetermined time period.

The calculating of the respective indexes for the software components and the test cases can include utilizing logistic regressions.

A non-transitory machine-readable medium can include program instructions that when executed perform embodiments of this method. A computing device can include a processor and a non-transitory machine-readable storage component, the storage component including program instructions that when executed by the processor perform embodiments of this method.

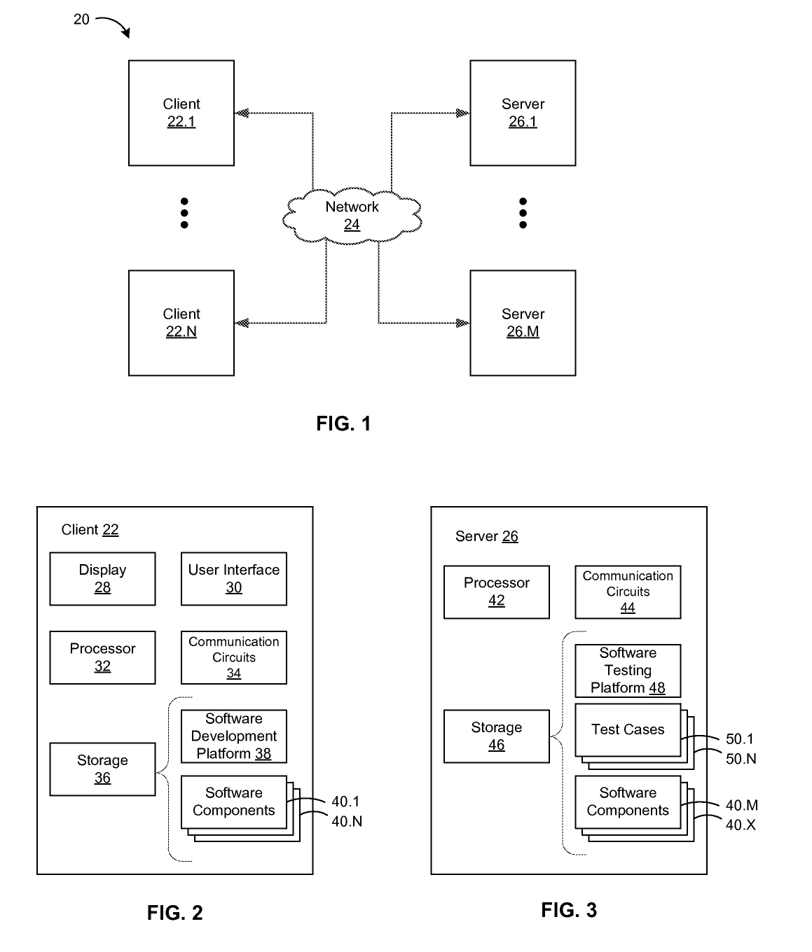

FIG. 1 depicts an embodiment of a software development and testing system 20 for use in developing and testing software. The depicted software development and testing system 20 can include one or more clients 22 (e.g., clients 22.1 . . . 22.N), a communication network 28, and one or more servers 26 (e.g., servers 26.1 . . . 26.M).

Each client 22 can provide a platform for a software developer to develop and test software components of a software system being developed. FIG. 2 depicts an embodiment of the client 22. The depicted client 22 can include a display 28, a user interface 30, a processor 32, communication circuits 34, and a storage component 36. The storage component 36 can store program instructions of a software development platform 38 and one or more software components 40 (e.g., software components 40.1 . . . 40.N) being developed and tested. The software development platform 38 can include program instructions that are executable by the processor to provide an environment to a developer using the client to develop and test the software components 40.

Returning to FIG. 1, the communication network 28 can provide communication of data between the clients 22 and servers 26, and can include one or more of portions of networks local to the clients 22 and/or servers 26 or portions of the Internet.

Each server 26 can provide software testing and development functions and services for software developers using the clients 22 to develop and test software components 40 of the software system being developed. FIG. 3 depicts an embodiment of the server 26. The depicted server 26 can include a processor 42, communication circuits 44, and a storage component 46. The storage component 46 can store program instructions of a software testing platform 48, one or more test cases 50 (e.g., test cases 50.1 . . . 50.N) for testing software components 40, and one or more software components 40 (e.g., software components 40.M . . . 40.X) being developed and tested. The software testing platform 48 can include program instructions that are executable by the processor 42 to provide an environment to test the software components 40.

The software development and testing system 20 can be used to provide an improved method of, and corresponding systems and apparatuses for, testing software, which ensures a high quality of the software being tested but does not prohibitively consume time or resources.

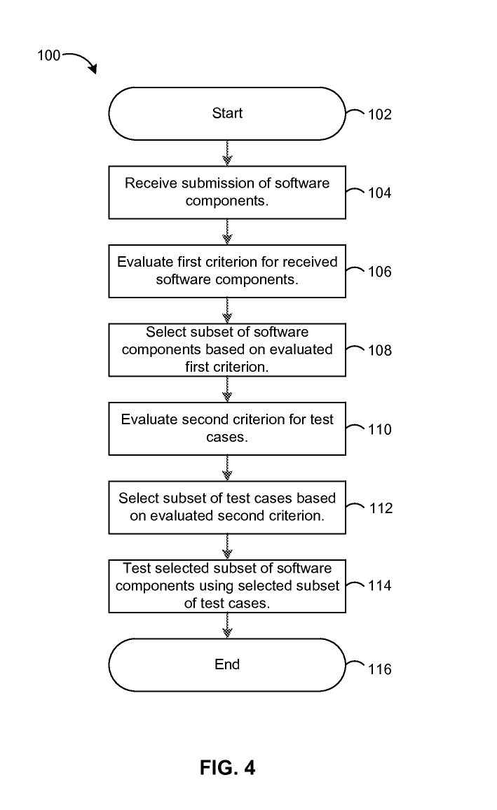

FIG. 4 depicts an embodiment of the method of testing software 100. The steps of the method 100 of FIG. 4 can each be performed by one or more components of the software development and testing system 20, such as by one or more components of one or more of the servers 26, including by the software testing platform 48 as executed by the processor 42 of the server 26 in conjunction with the operation of the communication circuits 44 and storage component 46 of the server 26 and the one or more clients 22. The method can start at step 102.

Submission of a plurality of software components 40 of the software system being developed can be received for testing at step 104.

Generally speaking, during a typical development cycle, a developer can spend a period of time developing the program instructions of a software component 40 according to intended specification of the development, and at the end of the period of time, submit the software component 40 to a software testing platform for purposes of having test cases 50 executed on the component to evaluate its quality with respect to the intended specification. Depending on the results of the testing, this development cycle can repeat one or more additional times for any particular software component 40 until the executed test cases 50 indicated a desired quality level. Additionally, for development of a large scale software system, many developers can engage in this development cycle with respect to many different software components 40.

The submission of the plurality of software components 40 can be received at one or more of the servers 26 from one or more of the clients 22. That is, the receiving of the submissions can result from one or more developers using one or more of the clients 22 to develop program instructions of the one or more software components 40 and then submitting the software components 40 from the clients 22 to the software testing platform 48 at one or more of the servers 26 for purposes of having test cases 50 executed on the components 40.

The submission of the plurality of software components 40 can be received over a predetermined time period. As discussed above, for development of a large scale software system, multiple developers can develop and submit for testing multiple software components 40. These submissions can be received at varying times and rates, and for purposes of performing the method, the submissions of the components 40 can be grouped as occurring during specific predetermined time periods.

Each of the software components 40 can include one or more sets of program instructions that are designated for testing as a unit. Each of the software components 40 can also take a variety of forms, such as including one or more files containing the one or more sets of program instructions of the component 40.

A first criterion can be evaluated for the received plurality of software components at step 106. The first criterion can be evaluated to aid in the subsequent selection of a subset of the received plurality of software components 40 to undergo testing, where the unselected portion of the receive plurality of software components 40 can remain untested. By testing only a selected subset of the received plurality of software components 40, the method 100 can provide an improved testing of large scale software systems by reducing the time and resources required to conduct the testing.

The first criterion can be evaluated in such a way as to result in the selection of a subset of the received plurality of software components 40 that will optimize the effectiveness of the testing by including software components 40 in the selected subset that may be most in need of testing, i.e., that may mostly likely be in a state upon submission that includes errors (also known as bugs) that may be revealed by testing, while excluding components 40 from the selected subset that may be relatively less in need of testing, i.e., that may mostly likely be in a state upon submission that does not include errors that may be revealed by testing. That is, the first criterion can be evaluated in such a way as to evaluate a perceived relative need of testing for each of the received plurality of software components 40.

The first criterion can be evaluated by calculating a respective numerical index for each of the received plurality of software components 40. The respective index can be calculated in various different ways to evaluate the perceived relative need of testing for the corresponding software component 40, including as a function of one or more factors as discussed below.

A first factor that can be used to calculate the respective index for a corresponding software component 40 can be a number of times that submission of the corresponding software component 40 has been received in a predetermined time period. This factor can thus incorporate into the calculation of the index a concept that the more often a particular software component 40 has been submitted in a particular time period, the more likely it is to contain errors.

A second factor that can be used to calculate the respective index for a corresponding software component 40 can be the times at which submission of the corresponding software component 40 has been received in a predetermined time period. This factor can thus incorporate into the calculation of the index a concept that the more recently a particular software component 40 has been submitted in a particular time period, the more likely it is to contain errors.

Note that the predetermined time periods considered in association with the above factors can be different from the predetermined time period over which the submission of the plurality of software components 40 can be received. The predetermined time periods considered in association with the above factors can be predetermined time periods selected and utilized to optimize the effectiveness of incorporating the above factors into the index calculation, whereas the predetermined time period over which submission of the plurality of software components 40 can be received can be a predetermined time period selected and utilized to identify a group of received software components 40 for testing purposes.

The respective index for the corresponding software component 40 can be calculated by utilizing a statistical model. For example, the respective index for the corresponding software component 40 can be calculated by utilizing a logistic regression. The logistic regression can be based on one or more of the above factors. For example, the respective index for the corresponding software component 40 can be calculated using a logistic regression according to the following formula:

$$Index = {\sum }_{i = 1}^{n} \frac{1}{( 1 + {e}^{- {at}_{i} + b} )} ; \qquad ( Eq . 1 )$$

where Index is the respective index calculated for the corresponding software component 40, n is the number of times that submission of the corresponding software component 40 has been received in a predetermined time period, tᵢ are normalized times of submission of the corresponding software component 40 during the predetermined time period, and a and b are selectable values.

Application of the formula of Eq. 1 to calculating the respective indexes for the corresponding software components 40 can be customized by adjusting the predetermined time period considered, the manner in which the times of submission of the corresponding software component 40 are normalized, and the selection of the values a, b. For example, the predetermined time period, the manner of normalization of the times of submission, and the values a and b can all be selected as a result of empirical analysis to have values optimized for identifying software components 40 most likely to contain errors. The predetermined time period, the manner of normalization of the times of submission, and the values a and b can all remain constant through more than one cycle of the method of testing 100 or can be continuously adjusted from cycle to cycle. Additionally, the predetermined time period can be selected to align to the software development project or a phase of the software development project; the times of submission can be normalized to a selected numerical range, such as a range of positive, negative or positive and negative values; and the values a, b, can optionally be selected to have numerical values greater than or equal to zero.

An example of an application of the formula of Eq. 1 to calculate the respective indexes for corresponding software components 40 can proceed as follows. In an exemplary scenario, a first software component 40 may be submitted three times over a predetermined time period, including a first time at the beginning of the predetermined time period, a second time at the midway point into the predetermine time period, and a third time at the end of the predetermined time period. A second software component 40 may be submitted eleven times over the same predetermined time period, including at equally spaced intervals staring at the beginning of the predetermined time period and ending at the end of the predetermined time period. The times of submission of the first and second software components 40 can be normalized to a selected numerical range, e.g., between −5 and 5, with the times of submission for the first software component 40 therefore being normalized to −5, 0, and 5, and the times of submission for the second software component 40 therefore being normalized to −5, −4, −3, −2, −1, 0, 1, 2, 3, 4 and 5. The constants a and b can be selected to be, e.g., 10 and 5, respectively. The formula of Eq. 1 can then be evaluated to calculate an index for the first software component 40 as follows:

$$Index = \frac{1}{1 + {e}^{55}} + \frac{1}{1 + {e}^{5}} + \frac{1}{1 + {e}^{- 45}} = 1.0067 ; \qquad ( Eq . 2 )$$

and for the second software component 40 as follows:

$$Index = \frac{1}{1 + {e}^{55}} + \frac{1}{1 + {e}^{45}} + \frac{1}{1 + {e}^{35}} + \frac{1}{1 + {e}^{25}} + \frac{1}{1 + {e}^{15}} + \frac{1}{1 + {e}^{5}} + \frac{1}{1 + {e}^{- 5}} + \frac{1}{1 + {e}^{- 15}} + \frac{1}{1 + {e}^{- 25}} + \frac{1}{1 + {e}^{- 35}} + \frac{1}{1 + {e}^{- 45}} = 5.0041 \qquad ( Eq . 3 )$$

The respective index for the corresponding software component 40 can also be calculated by utilizing other statistical models, such as at least one of: a discrete choice model, multinomial logistic regression, a mixed logit model, a probit, an ordered logit model, or a Poisson distribution.

A subset of the received plurality of software components can be selected based on the evaluated first criterion at step 108. As discussed above, the subset of the received plurality of software components 40 can be selected to undergo testing, while the unselected portion of the receive plurality of software components 40 can remain untested, and the first criterion can be evaluated to identify for selection the software components 40 that may be most in need of testing, while excluding the software components 40 from the selected subset that may be relatively less in need of testing.

The selecting of the subset of the received plurality of software components 40 can include selecting a predetermined percentage of the received plurality of software components 40 that may be in most need of testing based on the evaluated first criterion. Selecting a predetermined percentage of the received plurality of software components 40 that may be most in need of testing may greatly reduce the overall amount of testing required in comparison to testing all of the received plurality of software components 40, but still test most of the received software components 40 with errors based on a concept that most software components errors occur in only a relatively few of the received software components 40.

For evaluations of the first criterion that calculate a respective numerical index for each of the received plurality of software components 40, the predetermined percentage of the received software components 40 can be identified as the predetermined percentage of the received software components 40 having values that the numerical index is designed to indicated as the most in need of testing. For example, for a respective numerical index that yields a larger numerical value to indicate a higher need of testing, the predetermined percentage of the received plurality of software components 40 can be identified as that percentage of the received software components 40 for which the respective index yielded the largest numerical values. For a respective numerical index that yields a smaller numerical value to indicate a higher need of testing, the predetermined percentage of the received plurality of software components 40 can be identified as that percentage of the received software components 40 for which the respective index yielded the smallest numerical values.

A plurality of test cases 50, which can be collectively referred to as a test suite, can exist to test the received plurality of software components 40. Each of the test cases 50 can define at least one test to be executed to test a software component 40. Each of the test cases 50 can also take a variety of forms, such as including one or more files containing the definition of the at least one test and optionally program instructions to execute the at least one test.

A second criterion can be evaluated for the plurality of test cases for testing software components 40 of the software system being developed at step 110. The second criterion can be evaluated to aid in the selection of a subset of the plurality of test cases 50 to be executed on the selected subset of the received plurality of software components 40, while the unselected portion of the plurality of test cases 50 can remain unexecuted on the selected subset of the received plurality of software components 40. By executing only a selected subset of the plurality of test cases 50, the method 100 again provides an improved testing of large scale software systems by even further reducing the time and resources required to conduct the testing.

The second criterion can be evaluated in such a way as to result in the selection of a subset of the test cases 50 that will optimize the effectiveness of the testing by including test cases 50 in the selected subset that may be most likely to reveal errors in software components 40, while excluding test cases 50 from the selected subset that may be relatively less likely to reveal errors in the software components 40.

Similarly to evaluating the first criterion, the second criterion can be evaluated by calculating a respective numerical index for each of the plurality of test cases 50. The respective index can be calculated in various different ways to evaluate the perceived relative likelihood of the test cases revealing errors in software components 40, including as a function of one or more factors as discussed below.

A first factor that can be used to calculate the respective index for a corresponding test case 50 can be a number of times that the corresponding test case 50 has returned a failure result upon execution for any software component 40 of the software system in a predetermined time period. This factor can thus incorporate into the calculation of the index a concept that the more often a particular test case has returned a failure result in a particular time period, the more likely it is to return failure results at the time of evaluating the criterion.

A second factor that can be used to calculate the respective index for a corresponding test case 50 can be the times at which the corresponding test case 50 has returned failure results upon execution for testing any software components 40 of the software system in a predetermined time period. This factor can thus incorporate into the calculation of the index a concept that the more recently a test case 50 has returned a failure result in the predetermined time period, the more likely it is to return a failure result at the time of evaluating the criterion.

The predetermined time periods considered in association with the above factors for evaluating the second criterion can be different from both the predetermined time periods considered in association with the factors for evaluating the first criterion and from the predetermined time period over which the submission of the plurality of software components 40 can be received.

The respective index for the corresponding test case 50 can be calculated by utilizing a statistical model. For example, as with the first criterion, the respective index for the corresponding test case 50 can be calculated by utilizing a logistic regression. The logistic regression can be based on one or more of the above factors. For example, the respective index for the corresponding test case 50 can be calculated using a logistic regression according to the following formula:

$$Index = {\sum }_{i = 1}^{n} \frac{1}{( 1 + {e}^{- {at}_{i} + b} )} ; \qquad ( Eq . 4 )$$

where Index is the respective index calculated for the corresponding test case 50, n is the number of times that the corresponding test case 50 has returned a failure result for any software component 40 of the software system being developed in a predetermined time period, tᵢ are normalized times of the corresponding test case 50 returning failure result for any software component 40 of the software system being developed during the predetermined time period, and a and b are selectable values.

Application of the formula of Eq. 4 to calculating the respective indexes for the corresponding test cases 50 can be customized by adjusting the predetermined time period considered, the manner in which the times of failure results of the corresponding test cases 50 are normalized, and the selection of the values a, b. For example, the predetermined time period, the manner of normalization of the times of failure results, and the values a and b can all be selected as a result of empirical analysis to have values optimized for identifying test cases 50 most likely to reveal errors. The predetermined time period, the manner of normalization of the times of failure results, and the values a and b can all remain constant through more than one cycle of the method of testing 100 or can be continuously adjusted from cycle to cycle. Additionally, the predetermined time period can be selected to align to the software development project or a phase of the software development project; the times of failure results can be normalized to a selected numerical range, such as a range of positive, negative or positive and negative values; and the values a, b, can optionally be selected to have numerical values greater than or equal to zero.

An example of application of the formula of Eq. 4 to calculate respective indexes for corresponding test cases 50 can proceed as follows. In an exemplary scenario, a first test case 50 may return a failure result twice over a predetermined time period, including a first time at the beginning of the predetermined time period and a second time at the midway point into the predetermined time period. A second test case 50 may return a failure result five times over the same predetermined time period, including at equally spaced intervals staring at the beginning of the predetermined time period and ending prior to the end of the predetermined time period. The times of failure of the corresponding test cases 50 can again be normalized to a selected numerical range, e.g., between −5 and 5, with the times of failure for the first test case 50 therefore being normalized to −5, 0, and 5, and the times of failure for the second test case 50 therefore being normalized to −5, −3, −1, 1, and 3. The constants a and b can also again be selected to be, e.g., 10 and 5, respectively. The formula of Eq. 4 can then be evaluated to calculate an index for the first test case 50 of 0.0067 and an index for the second test case 50 of 1.9933.

The respective index for the corresponding test cases 50 can also be calculated by utilizing other statistical models, such as at least one of: a discrete choice model, multinomial logistic regression, a mixed logit model, a probit, an ordered logit model, or a Poisson distribution.

A subset of the plurality of test cases 50 can be selected based on the evaluated second criterion at step 112. As discussed above, the subset of the plurality of test cases 50 can be selected to be executed to test the selected subset of the received plurality of software components 40, while the unselected portion of the test cases 50 can remain unexecuted, and the second criterion can be evaluated to identify for selection test cases 50 that may be most likely to reveal errors, while excluding test cases 50 from the selected subset that may be relatively unlikely to reveal errors.

The selecting of the subset of the plurality of test cases 50 can include selecting a predetermined percentage of the plurality of test cases 50 that may be in most likely to reveal errors based on the evaluated second criterion. Selecting a predetermined percentage of the plurality of test cases 50 that may be most likely to reveal errors may greatly reduce the overall amount of testing required in comparison to executing all of the plurality of test cases 50, but still reveal most of the failure results returned by the plurality of test cases 50, based on the concept that most failure results occur by executing only a relatively few of the plurality of test cases 50.

For evaluations of the second criterion that calculate a respective numerical index for each of the plurality of test cases 50, the predetermined percentage can be identified as the predetermined percentage of the plurality of test cases 50 having values that the numerical index is designed to indicated as the most likely to reveal errors. For example, for a respective numerical index that yields a larger numerical value to indicate a greater likelihood of revealing errors, the predetermined percentage of the plurality of test cases 50 can be identified as that percentage of the plurality of test cases 50 for which the respective index yielded the largest numerical values. For a respective numerical index that yields a smaller numerical value to indicate a greater likelihood of revealing errors, the predetermined percentage of the plurality of test cases 50 can be identified as that percentage of the plurality of test cases 50 for which the respective index yielded the smallest numerical values.

The specific predetermined percentages used during the selection of the subsets of software components 40 and test cases 50 can be chosen in a various different ways. The specific predetermined percentages can be chosen to result in an acceptable total testing time for a predetermined period of software component submissions. Also, by way of analogy, the Pareto Principle, also known as the 80-20 rule, as it is sometimes applied in field of land ownership, states that 80% of the land is owned by 20% of the population. In the present context, this can be adapted to arrive at the concept that 80% of software errors are caused by only 20% of software components 40, and 80% of software errors cause only 20% of test cases 50 to return a failure result.

Thus, returning to the scenario discussed above where development of a large scale software system produces hundreds of software components 40 for potential testing each day, and executing an entire suite of test cases 50 on each of the components 40 may take dozens of computers upwards of hundreds of days to perform, by selecting for testing only 20% of the received plurality of software components 40 for testing and selecting only 20% of the plurality of test cases 50 for execution on the selected software components 40, the time for testing using the same test computers can be reduced to only several days.

Further time savings can be realized by selecting even lower predetermined percentages of software components 40 and test cases 50. With respect to the above example, selecting for testing only 10% of the received plurality of software components 40 for testing and selecting only 10% of the plurality of test cases 50 for execution on the selected software components 40 can further reduce the time for testing using the same test computers to only a single day. Continuing even further with this example, selecting for testing only 5% of the received plurality of software components 40 for testing and selecting only 5% of the plurality of test cases 50 for execution on the selected software components 40 can further reduce the time for testing using the same test computers to less than a single day.

The selected subset of the received plurality of software components 40 can be tested using the selected subset of the plurality of test cases 50 at step 114. In embodiments, only the selected subset of the received plurality of software components 40 are tested using only the selected subset of the plurality of test cases 50 at step 114, with the selected subset of the received plurality of software components 40 not being tested using the unselected subset of the plurality of test cases 50 and the unselected received plurality of software components 40 not being tested using any test case. The method 100 can end at step 116.

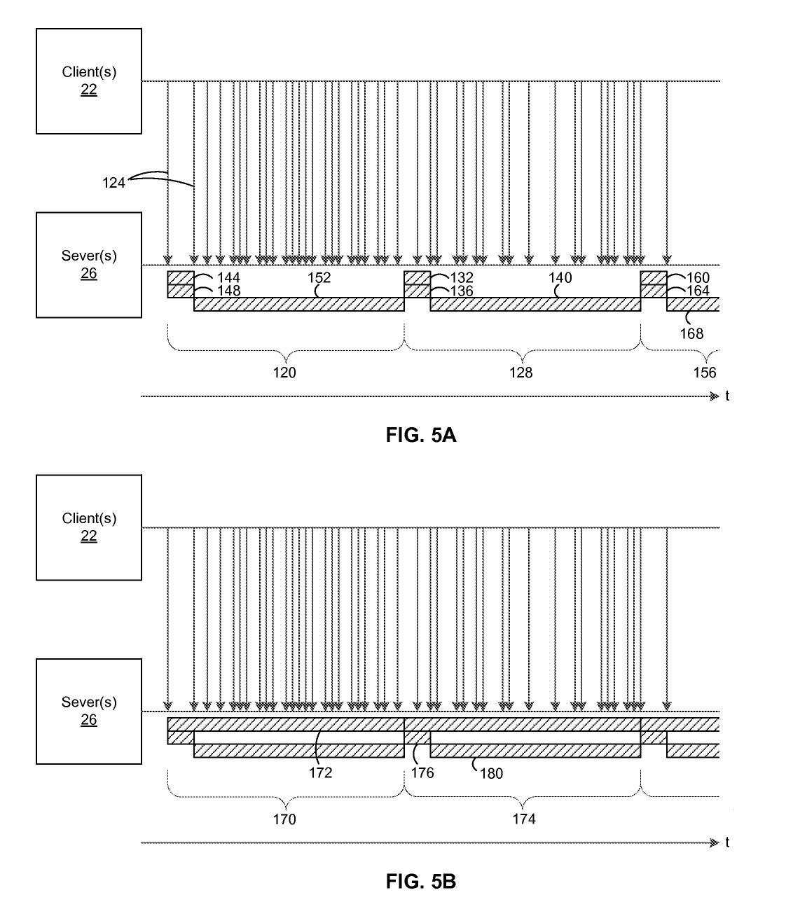

The steps of the method of testing software 100 can be performed in various ways and at various times during the development of the software system being developed, and can be performed in either a cyclical or non-cyclical fashion. FIG. 5A depicts an exemplary timeline of a performance of an embodiment of the method 100 during development of the software system. In the depicted timeline, the method 100 can be performed in a cyclical fashion. During a first predetermined time period 120, submission 124 of the plurality of software components 40 can be received at one or more servers 26 from one or more clients 22 as in step 104 of the method 100. At the end of this predetermined time period 120, and during a next predetermined time period 128, the first and second criteria can be evaluated and the subsets of the received software components 40 and the test cases 50 can be selected as in steps 106, 108, 110, 112 of the method 100 and as depicted by blocks 132 (for steps 106, 108), 136 (for steps 110, 112) in FIG. 5A. Also during the next predetermined time period 128, after the subsets of software components 40 and test cases 50 have been selected, the selected subset of software components 40 can be tested using the selected subset of test cases 50 as in step 114 and as depicted by block 140 in FIG. 5A.

As indicated, the exemplary timeline depicts a cyclical performance the method. Thus, during the first predetermined period 120, the first and second criteria can be evaluated and the subsets of the received software components 40 and the test cases 50 can be selected as in steps 106, 108, 110, 112 of the method 100 and as depicted by blocks 144 (for steps 106, 108), 148 (for steps 110, 112) in FIG. 5A for a plurality of software components 40 received during a predetermined time period of submissions (not shown) prior to the first predetermined period 120, and after the subsets of software components 40 and test cases 50 have been selected, the selected subset of software components 40 can be tested using the selected subset of test cases 50 as in step 114 of the method 100 and as depicted by block 152 in FIG. 5A. Likewise, during a third predetermined time period 156, the first and second criteria can be evaluated and the subsets of the software components 40 and the test cases 50 can be selected as in steps 106, 108, 110, 112 in the method 100 and as depicted by blocks 160 (for steps 106, 108), 164 (for steps 110, 112) in FIG. 5A for a plurality of software components 40 received during the second predetermined time period, and after the subsets of software components 40 and test cases 50 have been selected, the selected subset of software components 40 can be tested using the selected subset of test cases 50 as in step 114 of the method 100 and depicted by block 168 in FIG. 5A. This pattern can be repeated any number of times during development of the software system.

Other alignments of the steps of the method of testing software 100 to the development of the software system are also possible. FIG. 5B depicts another exemplary timeline of a performance of an embodiment of the method 100 during development of the software system. In the depicted timeline, the performance of various steps of the method can be the same as depicted in FIG. 5A and discussed above, except that instead of evaluating the first criterion during the next predetermined time period 174 for software components received during the first predetermined time period 170, the first criterion can be evaluated and the subset of the plurality of received software components can be selected on an ongoing basis for software components as they are received during the first predetermined 170 time period as in steps 106, 108 of the method 100 and as depicted by block 172 in FIG. 5B. Then, during the next predetermined period 174, as in FIG. 5A, the second criteria can be evaluated and the subset of the test cases can be selected as in steps 110, 112 of the method 100 and as depicted by block 176 in FIG. 5B, and the selected subset of software components can be tested using the selected subset of test cases as in step 114 of the method 100 and as depicted by block 180 in FIG. 5B.

Still other alignments of the steps of the method of testing software 100 to the development of the software system are also possible.

Other embodiments of the software development and testing system 20 are also possible, such as which locate the software development platform 38 or a portion thereof on one or more of the severs 26 and/or locate the software testing platform 48 or a portion thereof on one or more of the clients 22. Similarly, in embodiments of the method of testing software 100, any of the steps of the method 100 can be performed by various different computing devices, such as for example by one or more of the clients 22 or servers 26.

Additional embodiments of the software development and testing system 20 and the method of testing software 100 are possible. For example, any feature of any of the embodiments of the software development and testing system 20 and the method of testing software 100 described herein can optionally be used in any other embodiment of the software development and testing system 20 and the method of testing software 100. Also, embodiments of the software development and testing system 20 and the method of testing software 100 can optionally include any subset or ordering of the features of the software development and testing system 20 and the method of testing software 100 described herein.

What is claimed is:

1. A method of testing software, the method comprising:
evaluating, by at least one computing device, a first criterion for a plurality of software components;
selecting, by the at least one computing device, a subset of the plurality of software components based on the evaluated first criterion;
evaluating, by the at least one computing device, a second criterion for a plurality of test cases, each test case defining a respective test to evaluate functionality of at least one of the software components;
selecting, by the at least one computing device, a subset of the plurality of test cases based on the evaluated second criterion; and
testing, by the at least one computing device, the selected subset of the plurality of software components utilizing the selected subset of the plurality of test cases.

2. The method of claim 1, wherein the evaluating of the first criterion includes calculating a respective index for each of the plurality of software components.

3. The method of claim 2, wherein the selecting of the subset of the plurality of software components includes selecting a predetermined percentage of the plurality of software components based on the calculated indexes for the plurality of software modules.

4. The method of claim 2, wherein the respective index is a function of a number of times submission of the corresponding software component has been received in a predetermined time period.

5. The method of claim 2, wherein the respective index is a function of times at which submission of the corresponding software component has been received in a predetermined time period.

6. The method of claim 2, wherein the calculating of the respective index includes utilizing a logistic regression.

7. The method of claim 2, wherein the respective index is calculated according to the following formula:
$$index = {\sum }_{i = 1}^{n} \frac{1}{( 1 + {e}^{- {at}_{i} + b} )} ;$$
where n is a number of times submission of the corresponding software component has been received in a predetermined time frame, tᵢ is a normalized time of submission of the corresponding software component within the predetermined time frame, and a and b are selectable constants.

8. The method of claim 1, wherein the evaluating of the second criterion includes calculating a respective index for each of the plurality of test cases.

9. The method of claim 8, wherein the selecting of the subset of the plurality of test cases includes selecting a predetermined percentage of the plurality of test cases based on the calculated indexes for the plurality of test cases.

10. The method of claim 8, wherein the respective index is a function of a number of times the corresponding test case has returned a failure result in a predetermined time period.

11. The method of claim 8, wherein the respective index is a function of times at which the corresponding test case has returned the failure result in the predetermined time period.

12. The method of claim 8, wherein the calculating of the respective index includes utilizing a logistic regression.

13. The method of claim 8, wherein the respective index is calculated according to the following formula:
$$index = {\sum }_{i = 1}^{n} \frac{1}{( 1 + {e}^{- {at}_{i} + b} )} ;$$
where n is a number of times the corresponding test case has returned a failure result in a predetermined time frame, tᵢ is a normalized time of the failure result for the corresponding test frame within the predetermined time frame, and a and b are selectable constants.

14. A non-transitory machine-readable medium having program instructions, which when executed perform a method of testing software, the method comprising:
evaluating, by at least one computing device, a first criterion for a plurality of software components;
selecting, by the at least one computing device, a subset of the plurality of software components based on the evaluated first criterion;
evaluating, by the at least one computing device, a second criterion for a plurality of test cases, each test case defining a respective test to evaluate functionality of at least one of the software components;
selecting, by the at least one computing device, a subset of the plurality of test cases based on the evaluated second criterion; and
testing, by the at least one computing device, the selected subset of the plurality of software components utilizing the selected subset of the plurality of test cases.

15. The non-transitory machine-readable medium of claim 14, wherein the evaluating of the first criterion includes calculating a respective index for each of the plurality of software components.

16. The non-transitory machine-readable medium of claim 15, wherein the respective index is a function of at least one of a number of times submission of the corresponding software component has been received in a predetermined time period and times at which submission of the corresponding software component has been received in a predetermined time period.

17. The non-transitory machine-readable medium of claim 14, wherein the evaluating of the second criterion includes calculating a respective index for each of the plurality of test cases.

18. The non-transitory machine-readable medium of claim 17, wherein the respective index is a function of at least one of a number of times the corresponding test case has returned a failure result in a predetermined time period and times at which the corresponding test case has returned the failure result in the predetermined time period.

19. A computing device, comprising:
a processor; and
a non-transitory machine-readable storage component having program instructions, which when executed perform a method of testing software, the method including:
evaluating a first criterion for a plurality of software components;
selecting a subset of the plurality of software components based on the evaluated first criterion;
evaluating a second criterion for a plurality of test cases, each test case defining a respective test to evaluate functionality of at least one of the software components;
selecting a subset of the plurality of test cases based on the evaluated second criterion; and
testing the selected subset of the plurality of software components utilizing the selected subset of the plurality of test cases.

20. The computing device of claim 19, wherein:
the evaluating of the first criterion includes calculating a respective index for each of the plurality of software components, the respective index for a corresponding software module being a function of at least one of a number of times submission of the corresponding software component has been received in a predetermined time period and times at which submission of the corresponding software component has been received in a predetermined time period, and
the evaluating of the second criterion includes calculating a respective index for each of the plurality of test cases, the respective index for a corresponding test case being a function of at least one of a number of times the corresponding test case has returned a failure result in a predetermined time period and times at which the corresponding test case has returned the failure result in the predetermined time period.
